(19) United States
(12) Patent Application Publication
(10) Pub. No.: US 2009/0039791 A1
(43) Pub. Date: Feb. 12, 2009

(54) Entryway lighting system

(76) Inventor: Steve Jones, Holt, MI (US)

Correspondence Address: Ian C. McLeod;IAN C. McLEOD, P.C., 2190 Commons Parkway, Okemos, MI, 48864, US

(21) Appl. No.: 12/217,033

(22) Filed: Jul. 1, 2008

Related U.S. Application Data
(60) Provisional application No. 60/958,093, filed on Jul. 2, 2007.

(51) Int. Cl. H01J 7/24; F21S 8/00

(52) U.S. Cl. 315/118; 362/152

(57) ABSTRACT

A disclosed entryway lighting system generally includes (a) a door assembly comprising a frame; (b) one or more high-intensity light fixtures mounted within the frame; (c) a power supply electrically connected in a circuit to the light fixtures; (d) a temperature sensor; and, (e) an electrical switch coupled to the temperature sensor and electrically connected to the circuit, the electrical switch having a cut-off temperature above which the light fixtures are turned off. The lighting system improves the visibility, aesthetic appearance, and security of a door mounted in the door assembly. The combination of the temperature sensor and the electrical switch provides an element of safety against excess heat generation and build-up that can result from the use of high-intensity lights.

### CROSS-REFERENCE TO RELATED APPLICATION

Priority is claimed to provisional application No. 60/958,093, filed Jul. 2, 2007, the entire disclosure of which is herein incorporated by reference.

### BACKGROUND OF THE DISCLOSURE

1. Field of the Disclosure

The present disclosure relates to an entryway lighting system. The lighting system uses high-intensity lights and includes a temperature sensor/electrical switch (e.g., a thermal overload switch) to protect the system from overheating.

2. Brief Description of Related Technology

U.S. Pat. No. 2,254,852 to Gray discloses illuminating attachments that can be installed in a door frame that can provide additional illumination at the entrance of a building. The attachment has a lamp housing enclosing an electric lamp. However, the power of the relatively weak lamp may be only a few watts, so it will generate very little heat. The only protection against overheating is provided as vent openings for the circulation of air through the housing.

U.S. Pat. No. 7,125,136 to Dedic et al. discloses a hollow doorframe having electroluminescent illumination system. Electroluminescent strips are used that include electroluminescent material preferably encased in a transparent or translucent electrically insulating material. The strips are placed in U-shaped channels in the side panel of the door, so that the egress doorframe is illuminated when power is applied to the strips. No higher intensity lights are used, since the strips provide for less power consumption and they are more robust than incandescent or fluorescent lighting fixtures.

U.S. Patent Application Publication No. 2004/0012951 to Pylkki et al. discloses a fire safety window unit. The window unit may include illumination elements on the window frame, including light emitting diodes, liquid crystal displays, electro luminescent strips and the like. The window unit may also include a light, such as a strobe light, a halogen light, an incandescent light, and the like. No protection against overheating is provided in the window unit.

U.S. Patent Application Publication No. 2006/0176697 to Arruda discloses a combination light fixture and motion sensor apparatus for mounting to the top of a doorjamb. The light fixture utilizes either incandescent or rapid-start fluorescent bulbs. No protection against overheating is provided in the window unit.

However, none of the related art teaches an entryway lighting system having high-intensity lights with protection against overheating. Therefore, there remains a need for an improved entryway lighting system having high-intensity lights and thermal overload protection to keep the system from overheating.

### SUMMARY

The present disclosure provides an entryway lighting system that includes a door assembly having a frame, one or more high-intensity light fixtures mounted within the frame, a power supply electrically connected in a circuit to the high-intensity light fixtures, a temperature sensor, and an electrical switch coupled to the temperature sensor. The electrical switch is electrically connected to the circuit and has a cut-off temperature such that (i) the electrical switch is in an open position when the temperature sensor detects a temperature exceeding the cut-off temperature and (ii) the electrical switch is in a closed position when the temperature sensor detects a temperature below the cut-off temperature. The open/closed positions of the temperature sensor either interrupt/complete the electrical lighting circuit, thereby either preventing/allowing the operation of the high-intensity light fixtures.

The entryway lighting system provides several advantages. The high-intensity light fixtures improve the visibility, aesthetic appearance, and security of a door mounted in the door assembly. The combination of the temperature sensor and the electrical switch provides an element of safety against excess heat generation and build-up that can result from the use of high-intensity lights. Further, the mounted-in nature of the high-intensity light fixtures provides substantial accessibility and space-saving advantages as compared to mount-on units adaptable for use with conventional doors and/or door assemblies.

In one embodiment, an entryway lighting system comprises: (a) a door assembly comprising a frame; (b) one or more high-intensity light fixtures mounted within the frame of the door assembly; (c) a power supply electrically connected in a circuit (e.g., parallel or series) to the one or more high-intensity light fixtures; (d) a temperature sensor; and, (e) an electrical switch coupled to the temperature sensor and electrically connected to the circuit, the electrical switch having a cut-off temperature (e.g., about 40° C. to about 100° C.). The electrical switch is configured such that (i) the electrical switch is in an open position when the temperature sensor detects a temperature exceeding the cut-off temperature, thereby opening the circuit and preventing the operation of the high-intensity light fixtures; and (ii) the electrical switch is in a closed position when the temperature sensor detects a temperature below the cut-off temperature, thereby completing the circuit and allowing the operation of the high-intensity light fixtures.

In variations of the above embodiment, the frame comprises (i) an overhead lintel and (ii) first and second vertical side jambs connected to and spaced apart by the overhead lintel. Preferably, each of the overhead lintel, the first vertical side jamb, and the second vertical side jamb contains at least one high-intensity light fixture mounted therein. The door assembly can be fabricated from one or more of wood, metal, plastics, and fiberglass. Preferably, the high-intensity light fixtures individually include a lamp bulb selected from incandescent lamps (e.g., halogen), fluorescent lamps, and/or high-intensity discharge lamps. The high-intensity light fixtures can individually have a power consumption ranging from about 5 W to about 50 W. The power supply preferably comprises a low-voltage power transformer supplying about 5 V to about 30 V to the circuit, and it can optionally be mounted within the frame of the door assembly. Preferably, the temperature sensor is mounted within the overhead lintel and/or is selected from bi-metal mechanical thermometers, electrical resistance thermometers, thermistors, and thermocouples. The electrical switch preferably is mounted within the frame of the door assembly, and can form an integrated unit with the temperature sensor. The lighting system can further include (i) a timer electrically connected to the circuit (which allows the operation of the high-intensity light fixtures at a pre-selected time interval) and/or (ii) a motion sensor attached to the door assembly and electrically connected to the circuit (which allows the operation of the high-intensity light fixtures in response to a detected motion).

In another embodiment, an entryway lighting system comprises: (a) a door assembly comprising a frame, the frame comprising (i) an overhead lintel and (ii) first and second vertical side jambs connected to and spaced apart by the overhead lintel; (b) a plurality of high-intensity light fixtures (e.g., halogen lamps individually having a power consumption ranging from about 10 W to about 30 W) mounted within the frame of the door assembly, the high-intensity light fixtures comprising incandescent lamps individually having a power consumption ranging from about 5 W to about 50 W; (c) a power supply electrically connected in a circuit to the one or more high-intensity light fixtures, the power supply comprising a low-voltage power transformer supplying about 5 V to about 30 V to the circuit; (d) a temperature sensor attached to the door assembly; and, (e) an electrical switch coupled to the temperature sensor and electrically connected to the circuit, the electrical switch having a cut-off temperature ranging from about 40° C. to about 100° C. The electrical switch is configured such that (i) the electrical switch is in an open position when the temperature sensor detects a temperature exceeding the cut-off temperature, thereby opening the circuit and preventing the operation of the high-intensity light fixtures; and (ii) the electrical switch is in a closed position when the temperature sensor detects a temperature below the cut-off temperature, thereby completing the circuit and allowing the operation of the high-intensity light fixtures. Further, each of the overhead lintel, the first vertical side jamb, and the second vertical side jamb contains at least one high-intensity light fixture mounted therein.

Also disclosed is a method of using any of the above entryway lighting system embodiments. The method comprises: (a) providing the entryway lighting system of any of the above embodiments; (b) specifying the cut-off temperature T_{c} (e.g., about 40° C. to about 100° C.); (c) specifying a temperature reset differential ΔTᵣ (e.g., any value ≧0° C., or about 5° C. to about 20° C.); (d) sensing an ambient temperature T with the temperature sensor; (e) opening the electrical switch when the sensed ambient temperature T increases and traverses the cut-off temperature T_{c}, thereby opening the circuit and preventing the operation of the high-intensity light fixtures; and (f) closing the electrical switch when the sensed ambient temperature T decreases and traverses a reset temperature T_{c}−ΔTᵣ, thereby completing the circuit and allowing the operation of the high-intensity light fixtures.

It is an object of the disclosure to provide a high-intensity entryway lighting system having high-intensity lights and thermal overload protection to keep the system from overheating.

These and other objects of the disclosure will become increasingly apparent with reference to the following drawings and embodiments.

Additional features of the disclosure may become apparent to those skilled in the art from a review of the following detailed description, taken in conjunction with the drawings, examples, and appended claims.

### BRIEF DESCRIPTION OF THE DRAWINGS

For a more complete understanding of the disclosure, reference should be made to the following detailed description and accompanying drawings wherein:

FIG. 1 illustrates one embodiment of an entryway lighting system 10 according to the disclosure installed in the door assembly frame 11 of a residential entryway.

FIG. 1A illustrates an exploded view of the lighting system 10 of FIG. 1.

FIG. 2 illustrates a circuit 110 for an entryway lighting system 10 according to the disclosure.

FIGS. 3A-3C are cross-sectional views of the lighting system 10 components, including the light fixtures 120 (FIG. 3A), the power supply 140 (FIG. 3B), the thermal overload switch 150 (FIG. 3C).

FIGS. 4A-4C are side views corresponding to FIGS. 3A-3C, respectively.

While the disclosed apparatus and methods are susceptible of embodiments in various forms, specific embodiments of the disclosure are illustrated in the drawings (and will hereafter be described) with the understanding that the disclosure is intended to be illustrative, and is not intended to limit the claims to the specific embodiments described and illustrated herein.

### DETAILED DESCRIPTION

An entryway lighting system according to the disclosure generally includes (a) a door assembly having a frame; (b) one or more high-intensity light fixtures mounted within the frame of the door assembly; (c) a power supply electrically connected in a circuit to the high-intensity light fixture(s); (d) a temperature sensor; and, (e) an electrical switch coupled to the temperature sensor and electrically connected to the circuit, the electrical switch having a cut-off temperature.

In one embodiment, the entryway lighting system can be installed in a residential entryway door. It can be retrofitted into an existing door frame, or it can be installed prior to door assembly. The lighting system provides illumination of the entry by directing the light emitted from the high-intensity lights strategically placed around the door assembly frame to illuminate the door. The lighting system also can backlight a custom storm door. The lighting system significantly increases the illumination of the entryway and provides a way to showcase both entryway door units and storm door units (if installed).

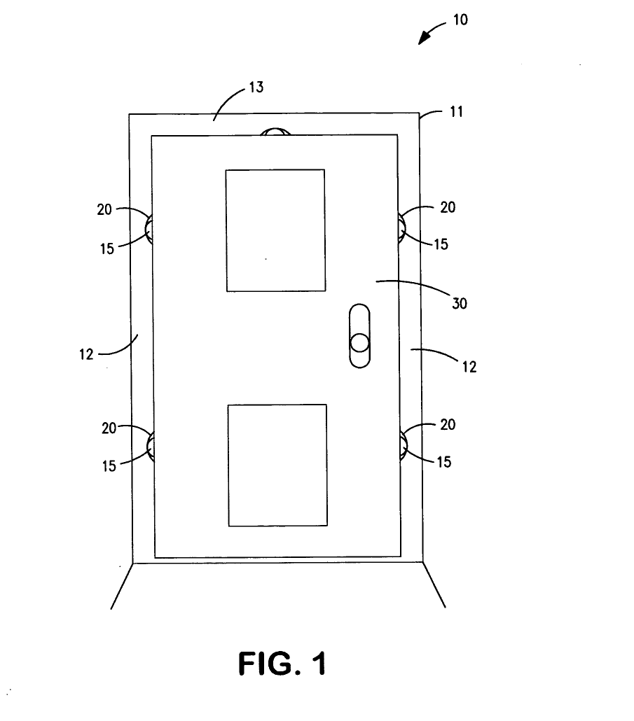

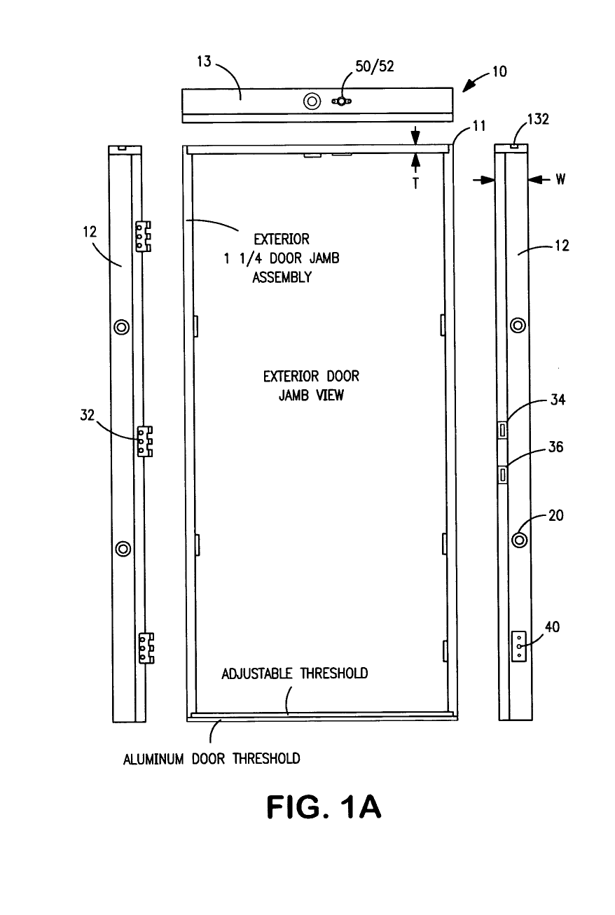

FIG. 1 illustrates an embodiment of an entryway lighting system 10. The lighting system 10 includes a door assembly having a frame 11 installed in a residential entryway with a door 30. FIG. 1A illustrates an exploded view of the entryway lighting system 10 of FIG. 1. The door assembly includes one or more high-intensity light fixtures 20 mounted at desired locations within the frame 11, the light fixtures 20 including high-intensity bulbs 15.

The term “frame” as used herein generally refers to a doorway structure which includes a vertical doorjamb and a horizontal overhead lintel. As illustrated, the frame 11 includes an overhead lintel (or doorjamb header) 13 as well as first and second vertical side jambs 12. The vertical side jambs 12 are connected to and spaced apart by the overhead lintel 13. In an embodiment, the light fixtures 20 are distributed around the perimeter of the frame 11 to enhance the visibility of the door 30. Preferably, at least one high-intensity light fixture 20 is mounted in each of the first vertical side jambs 12, the second vertical side jambs 12, and the overhead lintel 13, for example including five total light fixtures 20 as illustrated. The materials used to fabricate the various components of the door assembly are not particularly limited, and can include those materials generally used in conventional door assemblies. Examples of suitable materials include wood (e.g., hardwood, finger-jointed wood), metal (e.g., aluminum, steel, alloys of various metals), plastics/polymers (e.g., PVC vinyl), and/or fiberglass.

The term “high-intensity light fixtures” as used herein refers to any fixtures that provide bright, high-intensity light. The high-intensity light substantially enhances the visibility of the door 30 (e.g., in particular in low-light ambient conditions) and can accentuate the aesthetic appearance of the door 30. The high-intensity light also enhances safety by illuminating the entryway and rendering visible persons approaching the door 30. The bright, high-intensity light associated with the high-intensity light fixtures 20 generally results in a substantial amount of thermal heat generation and dissipation of the same to the surroundings, including the door 30 and elements of the lighting system 10 (e.g., components of the frame 11). When the heat generation is sufficient to raise the temperature of a portion of the door 30 and/or the lighting system 10 above a safe temperature threshold (e.g., the cut-off temperature as discussed below), there is a potential for personal injury (e.g., due to a person's contact with a hot surface) or property damage (e.g., due to overheating of the door 30 and/or the lighting system 10). Accordingly, the lighting system 10 of the present disclosure obtains the benefit of bright, high-intensity light in a safe manner by also including a means for sensing temperature within the door assembly and means for switching opens the electrical circuit in the lighting system 10 in response to a temperature exceeding a cut-off temperature that suggests a thermal overload of the lighting system 10.

The particular type of bulbs 15 used in the high-intensity light fixtures 20 is not particularly limited. The high-intensity light fixtures 20 can includes lamp bulbs such as incandescent lamps (e.g., halogen, conventional inert gas), fluorescent lamps (e.g., compact fluorescent, conventional fluorescent tubes), and/or high-intensity discharge lamps (e.g., xenon, metal halide). Incandescent lamps are preferable, in particular halogen lamps. Some lighting fixtures may be unsuitable in certain embodiments. For example, electroluminescent lights often have an intensity that is undesirably low in certain applications. For a particular type of lamp, the light intensity and heat generation are generally proportional to power consumption (i.e., wattage). Accordingly, high-intensity light fixtures 20 individually having a power consumption ranging from about 5 W (watt) to about 50 W (alternatively about 10 W to about 40 W, about 10 W to about 30 W, about 10 W to about 20 W, or about 20 W) often provide a light of sufficient intensity and generate heat that is not so excessive as to routinely exceed the cut-off temperature. Alternatively, the high-intensity light fixtures 20 can be characterized according to their individual lumen rating, which preferably ranges from about 10 lm (lumen) to about 1000 lm (alternatively about 50 lm to about 700 lm, or about 100 lm to about 400 lm). Accordingly, the cumulative intensity of a plurality of light fixtures 20 in the lighting system 10 (e.g., 3 to 8 light fixtures, 4 to 6 light fixtures, or 5 light fixtures as illustrated in FIG. 1A) is higher, preferably ranging from about 50 lm to about 5000 lm (alternatively about 200 lm to about 3500 lm, or about 500 lm to about 2000 lm).

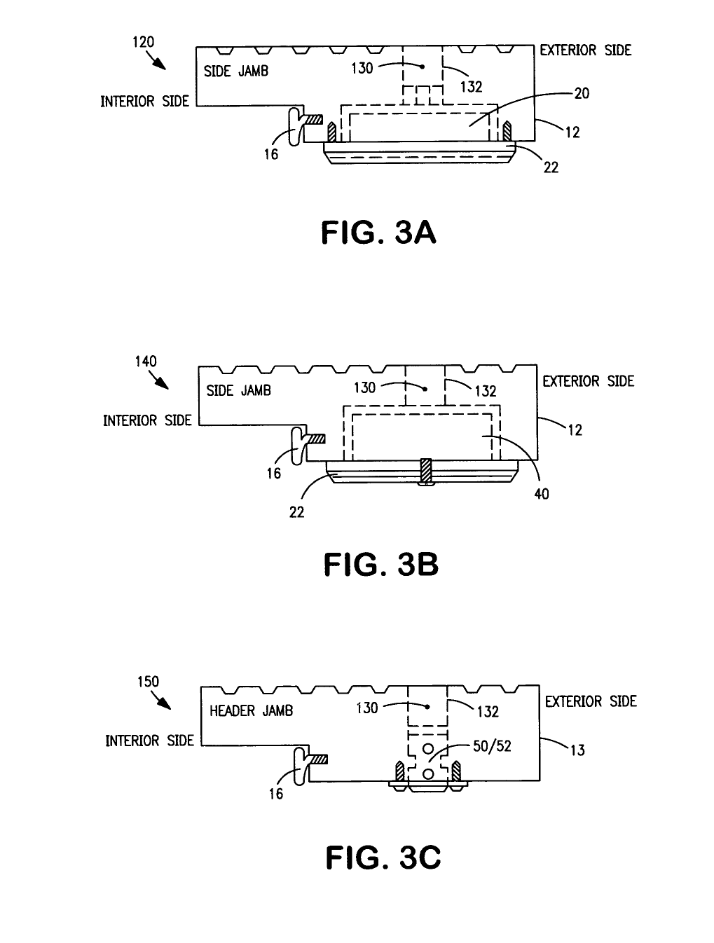

A preferred high-intensity light fixture 20 includes an incandescent halogen lamp bulb. Halogen lamp bulbs emit a relatively high intensity light in a relatively compact unit, generally with a potential drawback of increased heat generation. A compact size for the light fixture 20 is desirable given the limited space available in typical door assemblies. For example, a typical-frame 11 has a thickness T of about 3.2 cm (1¼ in; alternatively ranging from about 2 cm to about 5 cm, or about 2.5 cm to about 4 cm ) as illustrated in FIG. 1A. Similarly, the frame 11 typically has a width W of about 11.4 cm (4 9/16 in; alternatively ranging from about 8 cm to about 15 cm, or about 10 cm to about 13 cm). Further, the inclusion of other conventional door components into the frame (e.g., a compression weather seal (not shown), a hinge 32, a deadbolt plate 34, a strike plate 36) can reduce the usable space to a mountable width of about 5 cm to about 7 cm. The thickness T and the width W can apply to either or both of the vertical side jambs 12 and the overhead lintel 13. Despite these small dimensions, suitable halogen lamp bulbs can be mounted within (preferably entirely within) the frame 11 while leaving sufficient clearance for a routed wiring channel 132, as illustrated in FIGS. 3A-3C. An example of a suitable, commercially available halogen lamp bulb is the 12 V T3 2-pin (G4) bulb available from GE Lighting, which has a footprint of about 3.2 cm×1 cm (length x diameter), a power consumption of about 20 W, and a lumen rating of about 320 lm. Other lamp types (halogen or otherwise) that have a desirable combination of compact size and high-intensity light would also be suitable.

The lighting system 10 includes a power supply 40 electrically connected in a circuit to the one or more high-intensity light fixtures 20. As illustrated in FIG. 1A, the power supply 40 is preferably mounted within the frame 11 of the door assembly. In this case, the power supply preferably satisfies the same space constraints as the compact light fixtures 20. However, the power supply 40 also can be positioned remotely/externally from the lighting system 10. The power supply 40 can generally include any voltage source, including but not limited to a power transformer or other power source. The power supply 40 can provide either AC or DC power. For safety reasons, the power supply 40 is preferably a low voltage power transformer, for example supplying less than about 30 V (alternatively about 5 V to about 30 V, about 10 V to about 20 V, or about 12 V). An example of a suitable, commercially available low voltage power transformer is a 12 V AC transformer available from Westek Electronics (Santa Cruz, Calif.; model number: WTKBET1201H5), which has a size of about 7.6 cm×12.7 cm×3.8 cm (width×length×thickness; preferably remotely positioned from the lighting system 10). In other embodiments, however, higher voltage sources can be used. For example, the power supply 40 can simply be a connection to a conventional power source of about 120 V AC (e.g., a residential power source). In this case, in particular if the lighting system 10 is installed outdoors, a ground fault interrupter is preferably installed with the lighting system 10.

The lighting system 10 also includes a temperature sensor 50 to detect temperature increases resulting from the high-intensity light fixtures 20 and suggesting a potential thermal overload of the lighting system 10. Preferably, the temperature sensor 50 is attached to the door assembly. However, the temperature sensor 50 need not be attached to the door assembly, for example being externally mounted in the vicinity of the door assembly or door 30, or even attached to (or within) the door 30 itself. Because the heat generated by the light fixtures 20 tends to rise, the temperature sensor 50 is preferably mounted in the overhead lintel 13, as illustrated in FIG. 1A. In alternate embodiments (not shown), the temperature sensor 50 can be mounted in other portions of the door assembly, and/or more than one temperature sensor 50 can be included in the lighting system 10. The type of temperature sensor 50 is not particularly limited, for example including any device able to measure one or more temperatures based on chemical, mechanical, electrical, etc. properties of the device. For example, the temperature sensor 50 can measure a single temperature (e.g., a temperature at or near the cut-off temperature), or the temperature sensor 50 can measure a continuum of temperatures (e.g., a range of temperatures spanning the cut-off temperature). Examples of suitable temperature sensors 50 include bi-metal mechanical thermometers, electrical resistance thermometers, thermistors, and/or thermocouples.

An electrical switch 52 is coupled to the temperature sensor 50 and electrically connected to the electrical circuit including the light fixtures 20 and the power supply 40. Preferably, the electrical switch 52 is mounted within the door assembly frame 11, for example in the overhead lintel 13. The electrical switch 52 generally includes any over-temperature protection device such as, but not limited to, a thermal switch, fuse, or cutoff. The electrical switch 52 can act as a thermal fuse that must be replaced after blowing, or it can act as a thermal switch/circuit breaker that can be reset (e.g., either automatically upon cooling of the lighting system 10 or manually).

The electrical switch 52 is normally closed at low (ambient) temperatures. The electrical switch 52 has a cut-off (or set-point) temperature and opens the circuit in response to a temperature (i.e., as measured by the temperature sensor 50) that exceeds the cut-off temperature which suggests thermal overload of one or more components of the circuit and/or the lighting system 10. Specifically, the electrical switch is in a closed position when the temperature sensor 50 detects a temperature that is below the cut-off temperature, thereby completing the electrical circuit and allowing the operation of the high-intensity light fixtures 20 by the power supply 40. Conversely, the electrical switch is in an open position when the temperature sensor detects a temperature that exceeds the cut-off temperature, thereby opening the circuit and preventing the operation of the high-intensity light fixtures 20 by interrupting the flow of current from the power supply 40. For example, during normal operation of the lighting system 10, the light fixtures 20 are powered on, and the temperature detected by the temperature sensor 50 is below the cut-off temperature. In such a case, the electrical switch 52 remains closed and the lighting system 10 operates for as long as it remains powered on (e.g., via a manual on/off switch controlled by the user (not shown)). However, under certain conditions (e.g., the lighting system 10 has been operating for an extended period, ambient environmental conditions prevent heat transfer away from the lighting system 10 and/or door 30), the temperature detected by the temperature sensor 50 can increase above the cut-off temperature. In such case, the electrical switch 52 opens, shutting off the lighting system 10 and preventing further (potentially dangerous) heat accumulation in the lighting system 10 and/or door 30.

The particular selection of a cut-off temperature may depend on a variety of factors. For example, if the lighting system 10 and/or door 30 are fabricated from relatively heat-sensitive or heat-conductive materials, the cut-off temperature may be relatively low, and vice versa when they are fabricated from heat-resilient or heat-insulated materials. Further, the lighting system 10 can be fabricated with a single, pre-determined cut-off temperature (e.g., fixed by a selection of hardware components), or the cut-off temperature can be user-selectable (e.g., via a programmable electronic control system). In suitable embodiments, the particularly selected cut-off temperature can be any value from about 40° C. to about 100° C. (alternatively about 50° C. to about 95° C., about 60° C. to about 95° C., or about 75° C. to about 90° C.).

Preferably, the electrical switch 52 is further configured to self-reset as the temperature detected by the temperature sensor 50 decreases below the cut-off temperature (i.e., due to the absence of further heat generation and heat dissipation to the environment), thus re-completing the circuit and allowing the light fixtures 20 to resume operation. While the electrical switch 52 can self-reset immediately once the cut-off temperature is no longer exceeded, it is preferable to incorporate an additional temperature reset differential into the electrical switch 52. In this case, the detected temperature must decrease below the cut-off temperature by the additional temperature reset differential before re-completing the circuit. This prevents the lighting system 10 from intermittently turning on and off (i.e., from flickering) when the detected temperature fluctuates at values around the cut-off temperature. Suitable values for the temperature reset differential can be about 5° C. or more, for example about 5° C. to about 20° C. or about 10° C. to about 15° C. For example, if the cut-off temperature is 90° C. and the temperature reset differential is 15° C., an initially cool (i.e., ambient temperature) lighting system 10 will shut off when the sensed temperature reaches 90° C. (or more), but the lighting system 10 will only self-reset and turn back on when the sensed temperature cools back down to 75° C. (or less).

The temperature sensor 50 and the electrical switch 52 can be coupled in any convenient manner (e.g., mechanical, electrical) so that the electrical switch 52 appropriately opens/closes above and below the cut-off temperature. In an embodiment, the temperature sensor 50 and the electrical switch 52 can be integrated into a single unit, as illustrated in FIG. 1A (as element “50/52”). An example of such an integrated unit is a bi-metal mechanical thermal electric switch, for example the SNAP-ACTION temperature controls (e.g., 36T series) available from TESTCO (Sunnyvale, Calif.). The switch is configured with a metallic disc that completes (or closes) an electrical circuit at low temperatures. As the temperature of the switch increases, the metallic disc deforms as a function of temperature such that the electrical circuit is interrupted (or opened) at or above a characteristic temperature of the switch. The switch can be selected so that its characteristic temperature corresponds to the desired cut-off temperature. The switch also self-resets as the temperature decreases, generally with a nominal temperature reset differential of about 15° C.

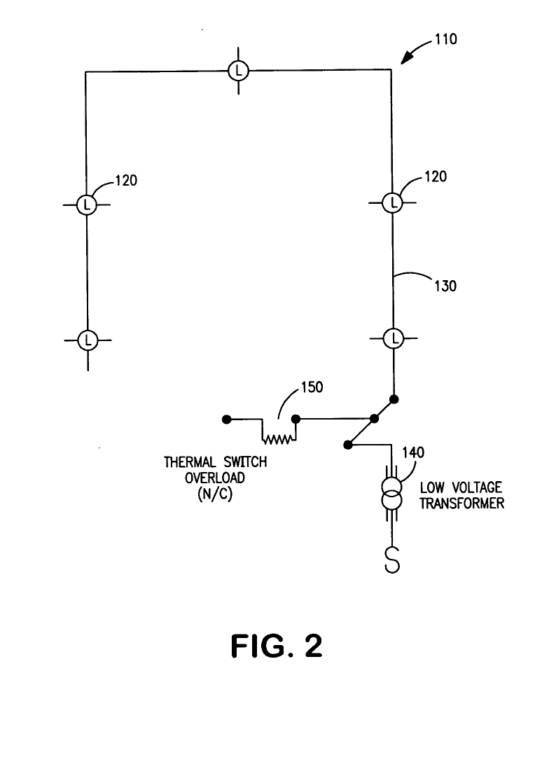

FIG. 2 illustrates a circuit 110 according to the disclosure. The circuit 110 for the entryway lighting system 10 has a plurality of high-intensity light fixtures 120 connected in series by electrical wiring 130. High-intensity bulbs, such as halogen bulbs (not shown), are placed into the light fixtures 120. The electrical wiring 130 also connects to a low-voltage power transformer 140 as the power supply for the circuit 110. A thermal overload switch 150 (e.g., an integrated temperature sensor and electrical switch as described above) is provided as a component of the circuit 110 such that the circuit 110 is opened and the high-intensity light fixtures 120 are turned off if the lighting system 10 becomes overheated. Alternatively, the components of the circuit 110 can be arranged in a parallel configuration.

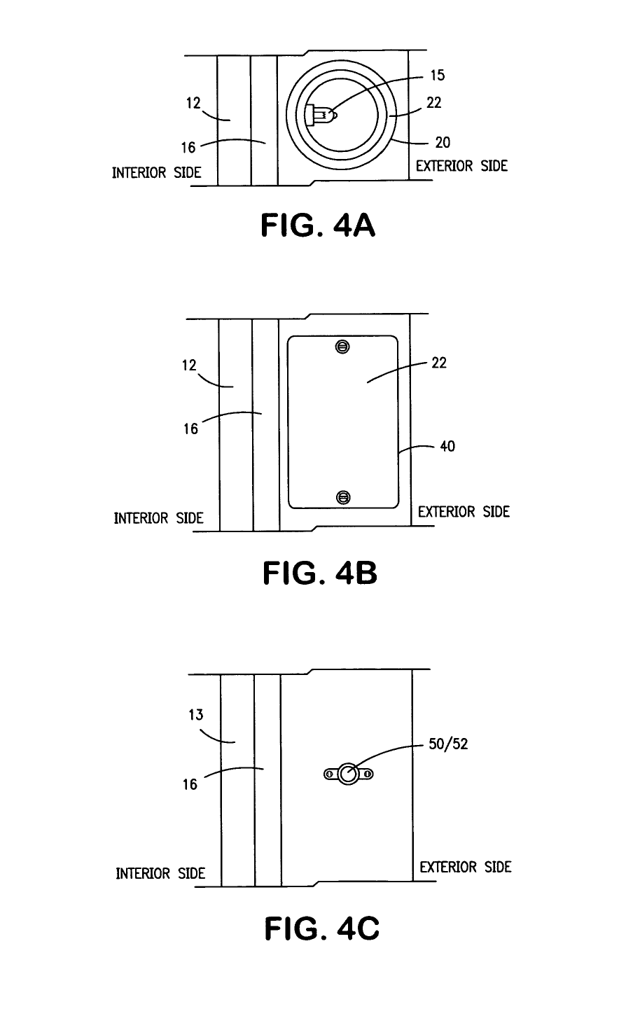

FIGS. 3A, 3B, and 3C are cross-sectional views of the lighting system 10 components, illustrating the manner in which the components can be mounted in the door assembly frame 11. FIG. 3A illustrates the portion of the vertical side jamb 12 containing one of the high-intensity light fixtures 20 that is adjacent the routed wire channel 132 and is electrically connected to the other components via the electrical wiring 130. FIG. 3A also illustrates the reduction in usable mounting space in the vertical side jamb 12 (or, equivalently, the overhead lintel 13) resulting from a compression weather seal 16. Similarly, FIG. 3B illustrates the portion of the vertical side jamb 12 containing the power supply 40, also connected to the circuit 110 via the electrical wiring 130. Both the light fixtures 20 and the power supply 40 are preferably protected from the environment via a weather-proof cover 22 (e.g., PVC vinyl or other weather-proof plastic) and can be mounted into the frame using a rubber or foam gasket (not shown). FIG. 3C illustrates the thermal overload switch 150 (e.g., an integrated temperature sensor 50 and electrical switch 52) mounted in the overhead lintel 13. FIGS. 4A-4C are side views corresponding to FIGS. 3A-3C, respectively.

The lighting system 10 can include a timer (not shown) electrically connected to the circuit. The timer allows the operation of the high-intensity light fixtures 20 at a pre-selected time interval and can be any sort of timer conventionally available, for example a (programmable) electrical or mechanical timer. During the time interval(s) at which the lighting system 10 is selected to be operating according to the timer setting, the lighting system 10 is still subject to shut-down via the temperature sensor 50 and the electrical switch 52, should the detected temperature exceed the cut-off temperature.

The lighting system 10 also can include a motion sensor (not shown) attached to the door assembly and electrically connected to the circuit. The motion sensor can control the operation of the high-intensity light fixtures 20, for example by activating the light fixtures 20 in response to a detected motion (e.g., a person approaching the door 30 from the outside or a person opening the door from the inside). Similar to the timer, however, the lighting system 10 is still subject to the control of the temperature sensor 50 and the electrical switch 52. Specifically, a motion sensor detecting a movement is unable to activate the lighting system 10 if the currently detected temperature by the temperature sensor 50 is above the cut-off temperature (or has not yet dropped below the cut-off temperature less the temperature reset differential). The particular type of motion sensor is not limited. For example, the motion sensor can be a normally-open, motion-activated switch that detects the motion of an approaching person within its field of view (e.g., optical or acoustical detection, for example using laser or infrared technology). When motion is detected, the normally-open switch is closed to complete the circuit and activate the light fixtures 20. When motion is no longer detected, the motion sensor/switch maintains its closed (ON) state for a selected period (the “delayed-OFF time”) before returning to its open (OFF) state. Thus, the light fixtures 20 remain on for the selected delayed-OFF time before automatically switching OFF. In an embodiment, a user may adjust the switch to choose a desired delayed-OFF time from a plurality of possible times (e.g., about 30 seconds, about 1, 2, 5, or 10 minutes, etc.). Further, when the motion sensor is included, it is preferably integrated into the circuit with a parallel bypass so that the lighting system can be powered on by the user at desired intervals, notwithstanding the presence or absence of a detected motion.

All patents, patent applications, government publications, government regulations, and literature references cited in this specification are hereby incorporated herein by reference in their entirety. In case of conflict, the present description, including definitions, will control.

Because other modifications and changes varied to fit particular operating requirements and environments will be apparent to those skilled in the art, the disclosure is not considered limited to the embodiments chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the apparatus or processes are described as including components, steps, or materials, it is contemplated that the apparatus or processes can also comprise, consist essentially of, or consist of, any combination of the recited components or materials, unless described otherwise.

What is claimed is:

1. An entryway lighting system comprising:
(a) a door assembly comprising a frame;
(b) one or more high-intensity light fixtures mounted within the frame of the door assembly;
(c) a power supply electrically connected in a circuit to the one or more high-intensity light fixtures;
(d) a temperature sensor; and,
(e) an electrical switch coupled to the temperature sensor and electrically connected to the circuit, the electrical switch having a cut-off temperature;
wherein:
(i) the electrical switch is in an open position when the temperature sensor detects a temperature exceeding the cut-off temperature, thereby opening the circuit and preventing the operation of the high-intensity light fixtures; and
(ii) the electrical switch is in a closed position when the temperature sensor detects a temperature below the cut-off temperature, thereby completing the circuit and allowing the operation of the high-intensity light fixtures.

2. The entryway lighting system of claim 1, wherein the frame comprises (i) an overhead lintel and (ii) first and second vertical side jambs connected to and spaced apart by the overhead lintel.

3. The entryway lighting system of claim 2, wherein each of the overhead lintel, the first vertical side jamb, and the second vertical side jamb contains at least one high-intensity light fixture mounted therein.

4. The entryway lighting system of claim 1, wherein the door assembly is fabricated to comprise one or more materials selected from the group consisting of wood, metal, plastics, fiberglass, and combinations thereof.

5. The entryway lighting system of claim 1, wherein the high-intensity light fixtures individually comprise a lamp bulb selected from the group consisting of incandescent lamps, fluorescent lamps, and high-intensity discharge lamps, and combinations thereof.

6. The entryway lighting system of claim 1, wherein the high-intensity light fixtures individually comprise an incandescent halogen lamp bulb.

7. The entryway lighting system of claim 1, wherein the high-intensity light fixtures individually have a power consumption ranging from about 5 W to about 50 W.

8. The entryway lighting system of claim 1, wherein the power supply comprises a low-voltage power transformer mounted within the frame of the door assembly.

9. The entryway lighting system of claim 1, wherein the power supply comprises a low-voltage power transformer supplying about 5 V to about 30 V to the circuit.

10. The entryway lighting system of claim 1, wherein the circuit is provided in a parallel or series configuration.

11. The entryway lighting system of claim 1, wherein the temperature sensor is selected from the group consisting of bi-metal mechanical thermometers, electrical resistance thermometers, thermistors, and thermocouples.

12. The entryway lighting system of claim 2, wherein the temperature sensor is mounted within the overhead lintel.

13. The entryway lighting system of claim 1, wherein the electrical switch is mounted within the frame of the door assembly.

14. The entryway lighting system of claim 1, wherein the cut-off temperature ranges from about 40° C. to about 100° C.

15. The entryway lighting system of claim 1, further comprising a timer electrically connected to the circuit, the timer allowing the operation of the high-intensity light fixtures at a pre-selected time interval.

16. The entryway lighting system of claim 1, further comprising a motion sensor attached to the door assembly and electrically connected to the circuit, the motion sensor allowing the operation of the high-intensity light fixtures in response to a detected motion.

17. An entryway lighting system comprising:
(a) a door assembly comprising a frame, the frame comprising (i) an overhead lintel and (ii) first and second vertical side jambs connected to and spaced apart by the overhead lintel;
(b) a plurality of high-intensity light fixtures mounted within the frame of the door assembly, the high-intensity light fixtures comprising incandescent lamps individually having a power consumption ranging from about 5 W to about 50 W;
(c) a power supply electrically connected in a circuit to the one or more high-intensity light fixtures, the power supply comprising a low-voltage power transformer supplying about 5 V to about 30 V to the circuit;
(d) a temperature sensor attached to the door assembly; and,
(e) an electrical switch coupled to the temperature sensor and electrically connected to the circuit, the electrical switch having a cut-off temperature ranging from about 40° C. to about 100° C.;
wherein:
(i) the electrical switch is in an open position when the temperature sensor detects a temperature exceeding the cut-off temperature, thereby opening the circuit and preventing the operation of the high-intensity light fixtures;
(ii) the electrical switch is in a closed position when the temperature sensor detects a temperature below the cut-off temperature, thereby completing the circuit and allowing the operation of the high-intensity light fixtures; and
(iii) each of the overhead lintel, the first vertical side jamb, and the second vertical side jamb contains at least one high-intensity light fixture mounted therein.

18. The entryway lighting system of claim 17, wherein the incandescent lamps comprise halogen lamps individually having a power consumption ranging from about 10 W to about 30 W.

19. A method of using an entryway lighting system, the method comprising:
(a) providing the entryway lighting system of claim 1;
(b) specifying the cut-off temperature T_{c};
(c) specifying a temperature reset differential ΔTᵣ;
(d) sensing an ambient temperature T with the temperature sensor;
(e) opening the electrical switch when the sensed ambient temperature T increases and traverses the cut-off temperature T_{c}, thereby opening the circuit and preventing the operation of the high-intensity light fixtures; and
(f) closing the electrical switch when the sensed ambient temperature T decreases and traverses a reset temperature T_{c}−ΔTᵣ, thereby completing the circuit and allowing the operation of the high-intensity light fixtures.

20. The method of claim 19, wherein the cut-off temperature T_{c} ranges from about 40° C. to about 100° C. and the temperature reset differential ΔTᵣ ranges from about 5° C. to about 20° C.
